(19) United States
(12) Patent Application Publication
(10) Pub. No.: US 2025/0378697 A1
(43) Pub. Date: Dec. 11, 2025

(54) SYSTEM AND METHOD OF FATIGUE DETECTION

(71) Applicants: Inventec (Pudong) Technology Corporation, Shanghai (CN); INVENTEC CORPORATION, TAIPEI CITY (TW)

(72) Inventors: Tse-Yu PAN, TAIPEI CITY (TW); Hung-Yao PENG, TAIPEI CITY (TW); Hsiao-Fen LU, TAIPEI CITY (TW); Chih-Kuei TU, TAIPEI CITY (TW); Shih-Hsin HSU, TAIPEI CITY (TW); Cheng-Yun WU, TAIPEI CITY (TW); Wei-Chao CHEN, TAIPEI CITY (TW); Chih-Pin WEI, TAIPEI CITY (TW)

(21) Appl. No.: 18/818,973

(22) Filed: Aug. 29, 2024

(30) Foreign Application Priority Data
Jun. 7, 2024 (CN) 202410742237.0

(51) Int. Cl. G06V 20/59; G06T 3/4046; G06T 3/4053; G06V 10/82; G06V 40/16; G10L 17/02; G10L 25/63

(52) U.S. Cl. CPC G06V 20/597; G06T 3/4046; G06T 3/4053; G06V 10/82; G06V 40/166; G06V 40/171; G06V 40/175; G10L 17/02; G10L 25/63

(57) ABSTRACT

A system of fatigue detection includes an image sensor, a voice sensor, a memory and a processor. The image sensor is configured to capture at least one facial image of a driver. The voice sensor is configured to collect a voice of the driver. The memory is configured to store the at least one facial image and the voice. The processor is configured to extract at least one micro-expression feature from the at least one facial image, and establish a fatigue detection model based on the at least one micro-expression feature, and utilize the fatigue detection model to obtain a fatigue detection result. The processor is further configured to utilize a voice detection algorithm to recognize the voice to obtain a voice recognition result. The processor is further configured to determine a mental state of the driver based on the fatigue detection result and the voice recognition result.

### RELATED APPLICATIONS

This application claims priority to China Application Serial Number 202410742237.0, filed on Jun. 7, 2024, which is herein incorporated by reference.

### BACKGROUND

### Technical Field

The present disclosure relates to a detection system and a detection method, and more particular to a fatigue detection system and a fatigue detection method.

### Description of Related Art

Most of the existing fatigue detection technologies directly utilize facial images for identification and analysis to determine the mental state of the driver. In the past, the problems faced by fatigue detection that only relies on facial images can be roughly divided into three types. First, if a machine learning model is utilized for fatigue detection, a large number of facial images is required for the machine learning model to perform feature extraction and training. Secondly, if lower resolution facial images are utilized for feature extraction and training, it may lead to the fatigue detection results are not as good as expected. The third is the misjudgment of fatigue status, for example, most existing methods determine whether the driver is yawning according to the mouth opening action, which tend to identify the speaking action of the driver as yawning, thus resulting in misjudgment of the fatigue status of the driver.

### SUMMARY

The object of the present disclosure is to provide a fatigue detection system and method. An image sensor is utilized to capture facial images of the driver while driving to establish a fatigue detection model, and obtain a fatigue detection result by the established fatigue detection model. The voice sensor is utilized to collect a voice of the driver while driving and recognizes the voice through a voice detection algorithm to obtain a voice recognition result. The mental state of the driver while driving is determined based on the obtained fatigue detection result and the obtained voice recognition result.

One aspect of the present disclosure relates to a fatigue detection system, which includes an image sensor, a voice sensor, a memory and a processor. The image sensor is configured to capture at least one facial image of a driver. The voice sensor is configured to collect a voice of the driver. The memory is configured to store the at least one facial image and the voice. The processor is configured to extract at least one micro-expression feature from the at least one facial image, and establish a fatigue detection model based on the at least one micro-expression feature, and utilize the fatigue detection model to obtain a fatigue detection result of the driver. The processor is further configured to utilize a voice detection algorithm to recognize the voice to obtain a voice recognition result of the driver. The processor is further configured to determine a mental state of the driver based on the fatigue detection result and the voice recognition result.

In accordance with one or more embodiments of the present disclosure, the processor is further configured to identify at least one facial region in the at least one facial image by utilizing a face detection algorithm.

In accordance with one or more embodiments of the present disclosure, the processor is further configured to utilize a micro-expression feature extraction algorithm to extract the at least one micro-expression feature in the at least one facial region.

In accordance with one or more embodiments of the present disclosure, the processor is further configured to process the at least one facial image by utilizing a generative adversarial network model to generate at least one super-resolution facial image.

In accordance with one or more embodiments of the present disclosure, the processor is further configured to extract the at least one micro-expression feature from the at least one facial image and the at least one super-resolution facial image.

Another aspect of the present disclosure relates to a fatigue detection method, which includes capturing at least one facial image of a driver; extracting at least one micro-expression feature from the at least one facial image; establishing a fatigue detection model based on the at least one micro-expression feature; utilizing the fatigue detection model to obtain a fatigue detection result of the driver; collecting a voice of the driver; utilizing a voice detection algorithm to identify the voice to obtain a voice recognition result of the driver; and determining a mental state of the driver based on the fatigue detection result and the voice recognition result.

In accordance with one or more embodiments of the present disclosure, the fatigue detection method further includes utilizing a face detection algorithm to identify at least one facial region in the at least one facial image.

In accordance with one or more embodiments of the present disclosure, the fatigue detection method further includes utilizing a micro-expression feature extraction algorithm to extract the at least one micro-expression feature in the at least one facial region.

In accordance with one or more embodiments of the present disclosure, the fatigue detection method further includes utilizing a generative adversarial network model to process the at least one facial image to generate at least one super-resolution facial image.

In accordance with one or more embodiments of the present disclosure, the fatigue detection method further includes extracting the at least one micro-expression feature from the at least one facial image and the at least one super-resolution facial image.

### BRIEF DESCRIPTION OF THE DRAWINGS

This disclosure can be more fully understood by reading the following detailed description of the embodiments, with reference made to the accompanying drawings as follows:

FIG. 1 is a functional block diagram of a fatigue detection system in accordance with some embodiments of the present disclosure.

FIG. 2 schematically illustrates the location of an image sensor relative to a driver.

FIG. 3 is a flowchart of a fatigue detection method in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are utilized in the drawings and the description to refer to the same or like parts.

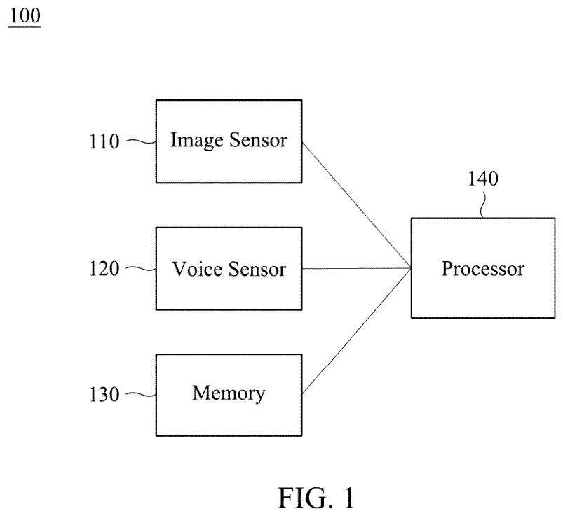

FIG. 1 is a functional block diagram of a fatigue detection system 100 in accordance with some embodiments of the present disclosure. The fatigue detection system 100 is suitable for a driver and includes an image sensor 110, a voice sensor 120, a memory 130, and a processor 140. The processor 140 may be disposed in, for example, a personal computer, a notebook computer, a tablet computer, or any suitable computing device, and the computing device may be connected to the image sensor 110 in any wired or wireless manner. The image sensor 110 is configured to capture at least one facial image of the driver, which may be a visible light sensor, a complementary metal-oxide-semiconductor (CMOS) image sensor, a charge-coupled device (CCD) image sensor, other light sensing components, other light sensing devices, or a combination of the above components, but is not limited to this. The voice sensor 120 is configured to collect a voice of the driver, and may be a microphone or other types of sound wave sensors. The memory 130 is configured to store the at least one facial image and the voice, which may be a random access memory (RAM), a read-only memory (ROM), a flash memory, a solid state drive (SSD), other similar components, or a combination of the above components, but is not limited to this. The processor 140 is coupled to the image sensor, the voice sensor and the memory, and is configured to extract micro-expression features from the at least one facial image, then establish a fatigue detection model based on these micro-expression features, and utilize the fatigue detection model to obtain a fatigue detection result of the driver. The processor 140 is further configured to utilize a voice detection algorithm to recognize the voice to obtain a voice recognition result of the driver. The processor 140 is further configured to determine a mental state of the driver based on the fatigue detection result and the voice recognition result. The processor 140 may be a central processing unit (CPU), a graphics processing unit (GPU), a microcontroller unit (MCU), a microprocessor, a system-on-chip (SoC), a digital signal processor (DSP), an application-specific integrated circuit (ASIC), a programmable logic controller (PLC), or a combination of the above components, but not limited to this.

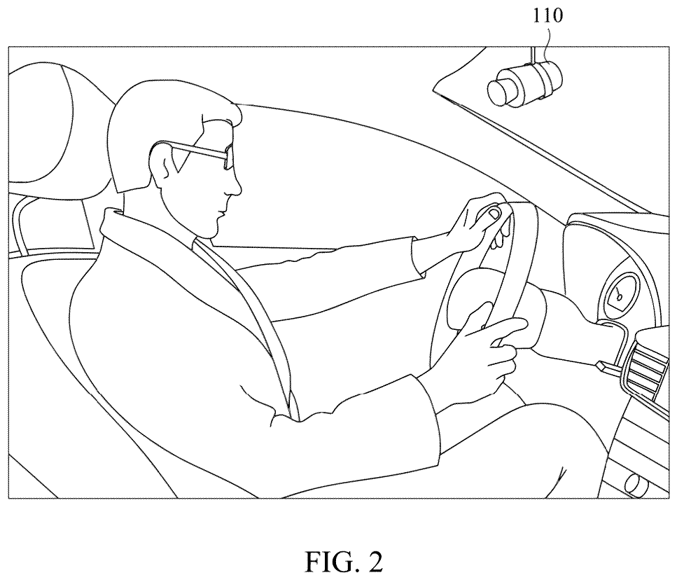

The image sensor 110 is disposed in front of a driver seat within a vehicle, as shown in FIG. 2, and the lens of the image sensor 110 is disposed toward the direction of the driver seat so as to capture the facial image of the driver while driving.

In some embodiments, the image sensor 110 is disposed on the interior rearview mirror, front windshield or at other locations within the vehicle (not shown in FIG. 2). The image sensor 110 is installed at a height close to the face of the driver, so that the facial image of the driver in the horizontal field of view may be captured from a bird's-eye view and a horizontal view while the driver is driving.

In some embodiments, the image sensor 110 is embedded/disposed in the dashboard, center console or at other locations within the vehicle (not shown in FIG. 2). The image sensor 110 is installed at a height lower than the face of the driver so as to capture the facial image of the driver from an upward perspective while the driver is driving.

It should be noted that the number of the image sensor 110 is only one in the embodiment shown in FIG. 2, but the present disclosure is not limited thereto. The number of the image sensor 110 may be increased or decreased according to different applications. For example, the number of the image sensor 110 may be two, three or more.

In general, since facial images of the driver while driving sensed by the image sensor 110 are continuous images, the number of facial images captured by the image sensor 110 is plural. After a plurality of facial images captured by the image sensor 110, the processor 140 is configured to access the facial images stored in the memory 130 and utilize a face detection algorithm to identify a facial region from each of the facial images.

After identifying the facial region from each of the facial images, the processor 140 is configured to utilize a micro-expression feature extraction algorithm to extract micro-expression features from each identified facial region.

After extracting micro-expression features from each identified facial region, the processor 140 is further configured to utilize the extracted micro-expression features as training data to establish a fatigue detection model, and then utilize the established fatigue detection model to obtain a fatigue detection result of the driver.

In the inference stage of the established fatigue detection model, the fatigue detection model may be utilized to classify facial images continuously input into the fatigue detection model, and a state of the driver while driving may be distinguished into two categories “fatigue” and “non-fatigue”, as the fatigue detection result output by the fatigue detection model in the inference stage.

It should be noted that the activation function is utilized to conduct probability regression of a multi-classification problem (in the embodiment of the present disclosure is a classification problem of “fatigue” and “non-fatigue”) in the training phase of the fatigue detection model. Therefore, the output of the fatigue detection model may be mapped to the two categories “fatigue” and “non-fatigue” through the activation function to regress the probability. In some embodiments, the activation function utilized for classification may be, for example, a Softmax function or other suitable activation function.

Since the fatigue detection model is established by utilizing machine learning methods, the collection of training data required to establish the model is particularly important. The amount and diversity of training data will directly affect the accuracy of the established fatigue detection model.

In view of the importance of the amount and diversity of training data in establishing the fatigue detection model, after the image sensor 110 captures facial images of the driver while driving, the processor 140 is configured to utilize a generative adversarial network (GAN) model to process the facial images to generate super-resolution facial images, and these super-resolution facial images have higher resolution than those facial images that have not been processed by the generative adversarial network model.

In one embodiment of the present disclosure, the number of super-resolution facial images generated by the generative adversarial network model is equal to the number of facial images that have not been processed by the generative adversarial network model.

In another embodiment of the present disclosure, the number of super-resolution facial images generated by the generative adversarial network model is greater than the number of facial images that have not been processed by the generative adversarial network model.

In yet another embodiment of the present disclosure, the number of super-resolution facial images generated by the generative adversarial network model is less than the number of facial images that have not been processed by the generative adversarial network model.

Regardless of whether the number of super-resolution facial images generated by the generative adversarial network model is equal to, more than, or less than the number of facial images that have not been processed by the generative adversarial network model, the amount and diversity of training data utilized to establish the fatigue detection model are increased. Specifically, the processor 140 is configured to extract micro-expression features from these facial images and these super-resolution facial images, that is, the facial images originally captured by the image sensor 110 and the super-resolution facial images generated by the generative adversarial network model are both utilized as training data to establish the fatigue detection model. In this way, the fatigue detection model may be generalized to low-resolution facial images (facial images originally captured by the image sensor 110) and high-resolution facial images (super-resolution facial images generated by the generative adversarial network model), the accuracy of the established fatigue detection model is thus improved.

If only facial images are utilized to determine whether the driver is in a “fatigue” state, misjudgments may occur in some cases, that is, the driver is not actually in a “fatigue” state, but is misjudged as being in a “fatigue” state by the fatigue detection model of the fatigue detection system 100. Since facial image recognition relies heavily on the characteristics of the eyes (for example, whether the eyes are closed or not) and the mouth (for example, whether the mouth is yawned or not) to determine the state of the driver. For example, even the opening and closing state of the driver's mouth while speaking may be misjudged by the fatigue detection model of the fatigue detection system 100 that the driver is in a “fatigue” state. In order to avoid the above-mentioned misjudgment by the fatigue detection model, the fatigue detection system 100 not only includes the image sensor 110 to capture facial images of the driver while driving, but also includes a voice sensor 120 to collect a voice of the driver while driving. The voice of the driver while driving is utilized to assist in determining whether the driver is indeed in a fatigued mental state or not while driving.

Similar to the image sensor 110, the voice sensor 120 may be disposed in front of the driver seat, on the interior rearview mirror, on the front windshield, in the dashboard (embedded setting), in the center console (embedded setting), or at other voice-receiving locations within the vehicle.

After the voice of the driver while driving is collected by the voice sensor 120, the processor 140 is configured to access the voice stored in the memory 130 and utilize a voice detection algorithm to identify the voice to obtain a voice recognition result of the driver, that is, the voice is distinguished into two categories “human voice” and “non-human voice” as the voice recognition result through the voice detection algorithm.

After the fatigue detection result and the voice recognition result of the driver are obtained, the processor 140 is then configured to determine the mental state of the driver based on the obtained fatigue detection result and the obtained voice recognition result. In one embodiment of the present disclosure, when the fatigue detection result of the driver is “fatigue” and the voice recognition result of the driver is “non-human voice”, it is determined that the driver is in a fatigued mental state; when the fatigue detection result of the driver is “fatigue” and the voice recognition result of the driver is “human voice”, it is determined that the driver is not in a fatigued mental state (possibly due to a misjudgment by the fatigue detection model); when the fatigue detection result of the driver is “non-fatigue” and the voice recognition result is “human voice”, it is determined that the driver is not in a fatigued mental state; when the fatigue detection result of the driver is “non-fatigue” and the voice recognition result is “non-human voice”, it is determined that the driver is not in a fatigued mental state. It should be noted that the present disclosure is not limited to this embodiment. The processor 140 is configured to determine the mental state of the driver in different situations based on the fatigue detection result and the voice recognition result of the driver while driving.

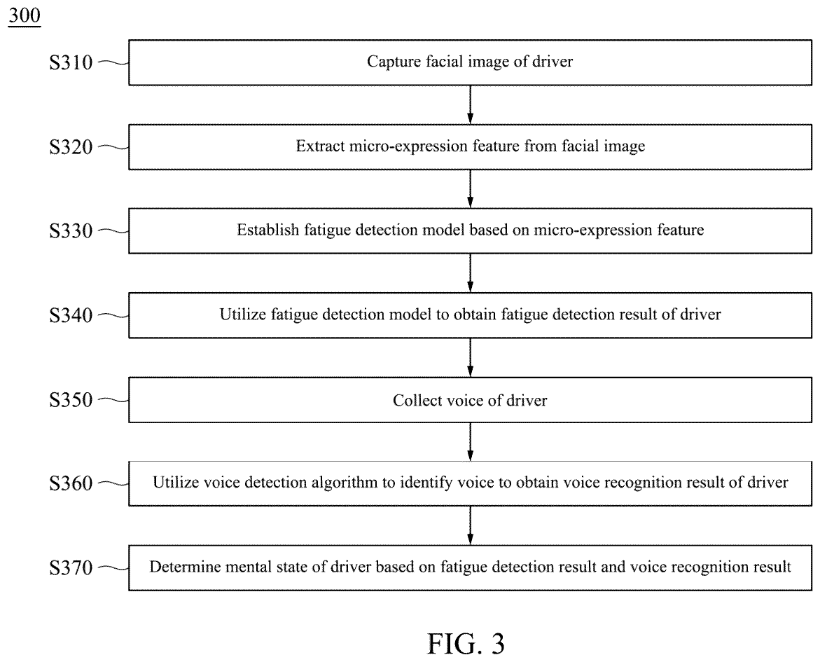

FIG. 3 is a flowchart of a fatigue detection method 300 in accordance with some embodiments of the present disclosure. The fatigue detection method 300 is suitable for a driver while driving, for example, the fatigue detection method 300 is suitable for the scene shown in FIG. 2, and may be utilized for a system including the image sensor, the voice sensor, the memory, and the processor shown in FIG. 1 (such as the fatigue detection system 100 shown in FIG. 1) or other similar systems. As shown in FIG. 3, the fatigue detection method 300 includes steps S310 to S370. The following paragraphs describe the implementation method of each step in conjunction with FIG. 1-3. The fatigue detection method 300 includes steps S310 to S370 described below.

Step S310: capture facial images of a driver. This step illustrates that an image sensor (such as the image sensor 110 in the fatigue detection system 100) is configured to collect facial images of the driver while driving. In some embodiments, the image sensor may be disposed in front of the driver seat (as shown in FIG. 2), on the interior rearview mirror, on the front windshield, in the dashboard (embedded setting), in the center console (embedded setting), or at other voice-receiving locations within the vehicle. It should be noted that the number of the image sensor is only one in the embodiment shown in FIG. 2, but the present disclosure is not limited thereto. The number of the image sensor may be increased or decreased according to different applications. For example, the number of the image sensor may be two, three or more.

Step S320: extract micro-expression features from the facial images. In general, since facial images of the driver while driving sensed by the image sensor are continuous images, the number of facial images captured by the image sensor is plural. After a plurality of facial images captured by utilizing the image sensor in Step S310, a face detection algorithm is utilized to identify a facial region from each of the facial images.

After identifying the facial region from each of the facial images, a micro-expression feature extraction algorithm is utilized to extract micro-expression features from each identified facial region.

Step S330: establish a fatigue detection model based on the micro-expression features. This step illustrates that after extracting micro-expression features from each identified facial region in Step S320, the extracted micro-expression features are utilized as training data to establish a fatigue detection model.

Step S340: utilize the fatigue detection model to obtain a fatigue detection result of the driver. This step illustrates that after the fatigue detection model is established by utilizing the extracted micro-expression features as training data in Step S330, the established fatigue detection model is utilized to obtain a fatigue detection result of the driver.

In the inference stage of the established fatigue detection model, the fatigue detection model may be utilized to classify facial images continuously input into the fatigue detection model, and a state of the driver while driving may be distinguished into two categories “fatigue” and “non-fatigue”, as the fatigue detection result output by the fatigue detection model in the inference stage.

It should be noted that the activation function is utilized to conduct probability regression of a multi-classification problem (in the embodiment of the present disclosure is a classification problem of “fatigue” and “non-fatigue”) in the training phase of the fatigue detection model. Therefore, the output of the fatigue detection model may be mapped to the two categories “fatigue” and “non-fatigue” through the activation function to regress the probability. In some embodiments, the activation function utilized for classification may be, for example, a Softmax function or another suitable activation function.

Since the fatigue detection model is established by utilizing machine learning methods, the collection of training data required to establish the model is particularly important. The amount and diversity of training data will directly affect the accuracy of the established fatigue detection model.

In view of the importance of the amount and diversity of training data in establishing the fatigue detection model, after facial images of the driver while driving captured by the image sensor, a generative adversarial network (GAN) model is utilized to process the facial images to generate super-resolution facial images, and these super-resolution facial images have higher resolution than those facial images that have not been processed by the generative adversarial network model.

In one embodiment of the present disclosure, the number of super-resolution facial images generated by the generative adversarial network model is equal to the number of facial images that have not been processed by the generative adversarial network model.

In another embodiment of the present disclosure, the number of super-resolution facial images generated by the generative adversarial network model is greater than the number of facial images that have not been processed by the generative adversarial network model.

In yet another embodiment of the present disclosure, the number of super-resolution facial images generated by the generative adversarial network model is less than the number of facial images that have not been processed by the generative adversarial network model.

Regardless of whether the number of super-resolution facial images generated by the generative adversarial network model is equal to, more than, or less than the number of facial images that have not been processed by the generative adversarial network model, the amount and diversity of training data utilized to establish the fatigue detection model are increased. Specifically, the micro-expression features are extracted from these facial images and these super-resolution facial images, that is, the facial images originally captured by the image sensor and the super-resolution facial images generated by the generative adversarial network model are both utilized as training data to establish the fatigue detection model. In this way, the fatigue detection model may be generalized to low-resolution facial images (facial images originally captured by the image sensor) and high-resolution facial images (super-resolution facial images generated by the generative adversarial network model), the accuracy of the established fatigue detection model is thus improved.

Step S350: collect a voice of the driver. This step illustrates that If only facial images are utilized to determine whether the driver is in a “fatigue” state, misjudgments may occur in some cases, that is, the driver is not actually in a “fatigue” state, but is misjudged as being in a “fatigue” state by the fatigue detection model. Since facial image recognition relies heavily on the characteristics of the eyes (for example, whether the eyes are closed or not) and the mouth (for example, whether the mouth is yawned or not) to determine the state of the driver. For example, even the opening and closing state of the driver's mouth while speaking may be misjudged by the fatigue detection model that the driver is in a “fatigue” state. In order to avoid the above-mentioned misjudgment by the fatigue detection model, In addition to the image sensor disposed in the vehicle to capture facial images of the driver while driving, a voice sensor is also disposed in the vehicle to collect the voice of the driver while driving to assist in determining whether the driver is indeed in a fatigued mental state or not while driving.

Similar to the image sensor, the voice sensor may be disposed in front of the driver seat, on the interior rearview mirror, on the front windshield, in the dashboard (embedded setting), in the center console (embedded setting), or at other voice-receiving locations within the vehicle.

Step S360: utilize a voice detection algorithm to identify the voice to obtain a voice recognition result of the driver. This step illustrates that after the voice of the driver while driving is collected by the voice sensor in Step S350, a voice detection algorithm is utilized to identify the voice to obtain a voice recognition result of the driver, that is, the voice is distinguished into two categories “human voice” and “non-human voice” as the voice recognition result through the voice detection algorithm.

Step S370: determine a mental state of the driver based on the fatigue detection result and the voice recognition result. This step illustrates that after the fatigue detection result and the voice recognition result of the driver are obtained in Step S360, the obtained fatigue detection result and the obtained voice recognition result are utilized to determine the mental state of the driver. In one embodiment of the present disclosure, when the fatigue detection result of the driver is “fatigue” and the voice recognition result of the driver is “non-human voice”, it is determined that the driver is in a fatigued mental state; when the fatigue detection result of the driver is “fatigue” and the voice recognition result of the driver is “human voice”, it is determined that the driver is not in a fatigued mental state (possibly due to a misjudgment by the fatigue detection model); when the fatigue detection result of the driver is “non-fatigue” and the voice recognition result is “human voice”, it is determined that the driver is not in a fatigued mental state; when the fatigue detection result of the driver is “non-fatigue” and the voice recognition result is “non-human voice”, it is determined that the driver is not in a fatigued mental state. It should be noted that the present disclosure is not limited to this embodiment. The mental state of the driver may be determined in different situations based on the fatigue detection result and the voice recognition result of the driver while driving.

As can be seen from the above description, the fatigue detection system and method of the present disclosure may be applied to a driver while driving. An image sensor is utilized to capture facial images of the driver while driving to establish a fatigue detection model, and obtain a fatigue detection result by the established fatigue detection model. The voice sensor is utilized to collect a voice of the driver while driving and recognizes the voice through a voice detection algorithm to obtain a voice recognition result. The mental state of the driver while driving is determined based on the obtained fatigue detection result and the obtained voice recognition result.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

What is claimed is:

1. A fatigue detection system, comprising:
an image sensor configured to capture at least one facial image of a driver;
a voice sensor configured to collect a voice of the driver;
a memory configured to store the at least one facial image and the voice; and
a processor coupled to the image sensor, the voice sensor, and the memory, the processor configured to extract at least one micro-expression feature from the at least one facial image, and establish a fatigue detection model based on the at least one micro-expression feature, and utilize the fatigue detection model to obtain a fatigue detection result of the driver,
wherein the processor is further configured to utilize a voice detection algorithm to identify the voice to obtain a voice recognition result of the driver, and
wherein the processor is further configured to determine a mental state of the driver based on the fatigue detection result and the voice recognition result.

2. The fatigue detection system of claim 1, wherein the processor is further configured to identify at least one facial region in the at least one facial image by utilizing a face detection algorithm.

3. The fatigue detection system of claim 2, wherein the processor is further configured to utilize a micro-expression feature extraction algorithm to extract the at least one micro-expression feature in the at least one facial region.

4. The fatigue detection system of claim 1, wherein the processor is further configured to process the at least one facial image by utilizing a generative adversarial network model to generate at least one super-resolution facial image.

5. The fatigue detection system of claim 4, wherein the processor is further configured to extract the at least one micro-expression feature from the at least one facial image and the at least one super-resolution facial image.

6. A fatigue detection method, comprising:
capturing at least one facial image of a driver;
extracting at least one micro-expression feature from the at least one facial image;
establishing a fatigue detection model based on the at least one micro-expression feature;
utilizing the fatigue detection model to obtain a fatigue detection result of the driver;
collecting a voice of the driver;
utilizing a voice detection algorithm to identify the voice to obtain a voice recognition result of the driver; and
determining a mental state of the driver based on the fatigue detection result and the voice recognition result.

7. The fatigue detection method of claim 6, further comprising:
utilizing a face detection algorithm to identify at least one facial region in the at least one facial image.

8. The fatigue detection method of claim 7, further comprising:
utilizing a micro-expression feature extraction algorithm to extract the at least one micro-expression feature in the at least one facial region.

9. The fatigue detection method of claim 6, further comprising:
utilizing a generative adversarial network model to process the at least one facial image to generate at least one super-resolution facial image.

10. The fatigue detection method of claim 9, further comprising:
extracting the at least one micro-expression feature from the at least one facial image and the at least one super-resolution facial image.
